(19) United States
(12) Patent Application Publication
(10) Pub. No.: US 2006/0116878 A1
(43) Pub. Date: Jun. 1, 2006

(54) Asthma diagnostic apparatus, asthma diagnostic method, and storage medium storing asthma diagnostic program

(75) Inventor: Kenji Nagamine, Naha (JP)

Correspondence Address: Patrick G. Burns, Esq.;GREER, BURNS & CRAIN, LTD., Suite 2500, 300 South Wacker Dr., Chicago, IL, 60606, US

(73) Assignees: Kenji Nagamine; David Albertus Messenger

(21) Appl. No.: 11/211,909

(22) Filed: Aug. 25, 2005

(30) Foreign Application Priority Data
Nov. 30, 2004 (JP) 2004-347410

(51) Int. Cl. G10L 15/12; G10L 21/06; G10L 15/08

(52) U.S. Cl. 704/239; 704/271

(57) ABSTRACT

An asthma diagnostic apparatus includes: a reference laughter storage unit storing the laughter of a mild asthmatic as reference data; an input unit inputting the laughter of a person to be diagnosed; a similarity determination unit determining the similarity between the laughter as reference data and the input laughter; and an output unit outputting a determination result of the similarity.

### BACKGROUND OF THE INVENTION

1. Field of the Invention

The present invention relates to an asthma diagnostic apparatus, an asthma diagnostic method, and a storage medium storing an asthma diagnostic program, and more specifically to an asthma diagnostic apparatus, an asthma diagnostic method, and a storage medium storing an asthma diagnostic program capable of performing a diagnosis of asthma on a mild asthmatic.

2. Description of the Related Art

The development of industries has generated various technologies and has greatly contributed to the improvement of human life. On the other hand, many technologies have caused air pollution. It is said that living in an environment of polluted air raises the probability of suffering from asthma.

According to the estimation of the Japanese Ministry of Health, Labour and Welfare in 2002, the number of asthmatic patients has exceeded one million. In the increasing number of the patients, approximately 4,000 patients died of asthmatic fits in 2001, and more than 3700 patients in 2002 and 2003.

When a patient has a fit, the patient requires inhaling or taking medicines depending on the level of the fit, and it is important to appropriately determine the state of the level of the fit and the bronchial tube, and take the patient to hospital by an ambulance as necessary. The Ministry of Health, Labour and Welfare has indicated a thorough medical guide generated by the study team of the Ministry of Health, Labour and Welfare to patients and their families, medical practitioners, etc. so that the above-mentioned measures can be quickly and correctly taken although they are not professional doctors, and generated a linked system involving an emergency medical organization, a medical clinic, etc., thereby indicating its policy of enhancing the initial aid.

Furthermore, the Ministry of Health, Labour and Welfare places prime importance on daily measures, and has indicated its policy of performing continuous diagnostics by constantly grasping the status of the bronchial tube of a patient using dedicated measuring equipment because there are a number of patients who are not aware of the importance of taking a long-term medicine to protect against a fit.

A mild asthmatic is in a state where an asthmatic sound can be slightly heard with a stethoscope. Therefore, some patients are hardly aware of the illness, and some doctors can hardly hear the asthmatic sound. As a result, during the period of mild asthma, the doctors frequently fail to detect the asthmatic sound, thereby causing a number of patients to be left without consultation with a doctor for a remedy.

Like other diseases, it is obvious that an appropriate measure is to be taken against asthma at the early stage of illness. Therefore, various asthma diagnostic tools have been devised.

For example, the aspiration status diagnostic tool disclosed by the following patent document 1 diagnoses illnesses of the lungs such as asthma, etc. by listening to the sound which occurs in artificial expiration and indicates the illness of the lungs.

[Patent Document 1] National Publication of International patent Application No. H03-503498 “Aspiration Status Diagnoses and Apparatus Thereof”

However, with the aspiration status diagnostic tool disclosed by the patent document 1, when the sound (asthmatic sound) indicating the illness of a lung such as asthma, etc. is heard, for example, a stethoscope can detect similar sounds indicating the illness of a lung. Therefore, it cannot be said that the diagnosis cannot be performed without such an aspiration status diagnostic tool.

### SUMMARY OF THE INVENTION

The present invention aims at providing an asthma diagnostic apparatus, an asthma diagnostic method, and a storage medium storing an asthma diagnostic program capable of easily detecting mild asthma when a person to be diagnosed suffers from the above-mentioned mild asthma.

The first aspect of the asthma diagnostic apparatus according to the present invention is an asthma diagnostic apparatus including a reference laughter storage unit for storing laughter of a mild asthmatic as reference data, an input unit for inputting the laughter of a person to be diagnosed, a similarity determination unit for determining the similarity between the laughter as reference data and the input laughter, and an output unit for outputting a determination result of the similarity.

Based on the fact determined by the Applicant that “regarding asthma, the status of the inside of a lung is reflected by laughter from the early stage of the illness”, the laughter of a mild asthmatic as reference data is compared with the laughter of a person to be diagnosed, and the similarity is discriminated, thereby determining whether or not a person to be diagnosed is a mild asthmatic.

The second aspect of the asthma diagnostic apparatus according to the present invention is an asthma diagnostic apparatus including a reference laughter storage unit for storing laughter of a mild asthmatic as reference data, an input unit for inputting the laughter of a person to be diagnosed, a laughter feature value calculation unit for calculating a feature value of input laughter or laughter as reference data, a feature value similarity determination unit for determining the similarity between a feature value of the laughter as reference data and a feature value of the input laughter, and an output unit for outputting a determination result of the similarity in the feature value.

Based on the fact determined by the Applicant that “regarding asthma, the status of the inside of a lung is reflected by laughter from the early stage of the illness”, a feature value of input laughter of a person to be diagnosed is extracted, and the extracted feature value of the laughter of the person to be diagnosed is compared with a feature value of laughter of a mild asthmatic as reference data, and the similarity is discriminated, thereby determining whether or not a person to be diagnosed is a mild asthmatic.

The third aspect of the asthma diagnostic server apparatus according to the present invention includes a reference laughter database for storing the laughter of a mild asthmatic as reference data, a similarity determination unit for receiving the laughter of a person to be diagnosed from a terminal for transmitting the laughter of the person to be diagnosed, and detecting the similarity between the laughter of the person to be diagnosed and the laughter as the reference data, and a transmission unit for returning a determination result of the similarity to the transmitting source terminal of the laughter of the person to be diagnosed.

The third aspect described above can further include a reference laughter data addition unit for adding the received laughter of the person to be diagnosed to the reference laughter database when the received laughter of the person to be diagnosed is determined as the laughter of a mild asthmatic in determining the similarity. With this configuration, the laughter of a mild asthmatic as reference data can be efficiently collected.

According to the present invention, based on the fact determined by the Applicant that “regarding asthma, the status of the inside of a lung is reflected by laughter from the early stage of the illness”, it can be determined whether or not a person to be diagnosed is a mild asthmatic.

Furthermore, when it is considered that asthma has been relieved, the asthma diagnostic apparatus according to the present invention is used again to determine whether or not mild asthma is still detected, thereby preventing a relapse due to unnecessarily ceasing medication prematurely.

Specifically, according to the present invention, a patient with mild asthmatic fits can be easily diagnosed.

### BRIEF DESCRIPTION OF THE DRAWINGS

FIG. 1A shows a voice waveform of the laughter of a patient with mild asthmatic fits;

FIG. 1B shows the voice waveform of laughter of a healthy person;

FIG. 2 is a block diagram of the configuration of the asthma diagnostic apparatus according to the first embodiment of the present invention;

FIG. 3 is a more detailed block diagram of the configuration shown in FIG. 2 when DP matching is used as an algorithm of voice recognition;

FIG. 4 shows an example of the configuration of the asthma diagnostic apparatus according to the first embodiment of the present invention;

FIG. 5 is a block diagram of the configuration of the asthma diagnostic apparatus according to the second embodiment of the present invention;

FIG. 6 is a more detailed block diagram of the configuration shown in FIG. 5 when DP matching is used as an algorithm of voice recognition;

FIG. 7 shows an example of the configuration of the asthma diagnostic apparatus according to the second embodiment of the present invention;

FIG. 8 shows the configuration of the asthma diagnostic system according to the third embodiment of the present invention; and

FIG. 9 shows an example of a storage medium.

### DESCRIPTION OF THE PREFERRED EMBODIMENTS

The embodiments of the present invention are described below in detail.

The present invention relates to the technology of diagnosing a patient as a mild asthmatic, but has an element of a heuristic task. Described briefly below is the process of the Applicant's discovery of the concept.

Over a long period of studying voice data from various viewpoints, the Applicant considers that once an inflammation occurs in the lung, the phlegm generated by the inflammation in the lung vibrates, and causes a difference between the voice uttered by a person with a pulmonary disease such as asthma compared to that of a healthy person.

The Applicant also considers that when there is lung disease, for example, asthma, the generated voice, especially laughter allows changes in the lungs to be detected from the early stages of the illness.

Since in the case of the Applicant, the Applicant has met a number of patients having illnesses of their lungs over an extended period of time, and has become particularly sensitively aware of the differences between the voices of patients and those of healthy persons, and the Applicant has learned to recognize the mild asthmatic especially from the laughter of a person to be diagnosed.

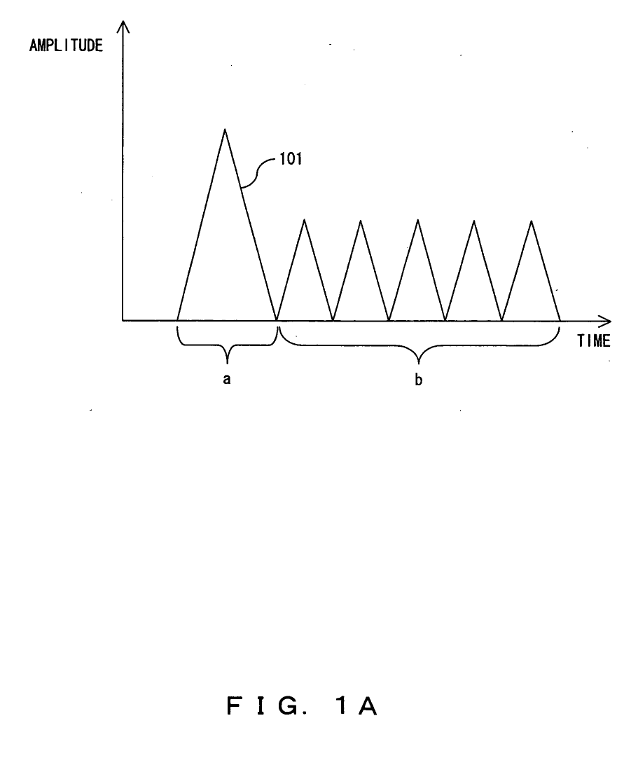

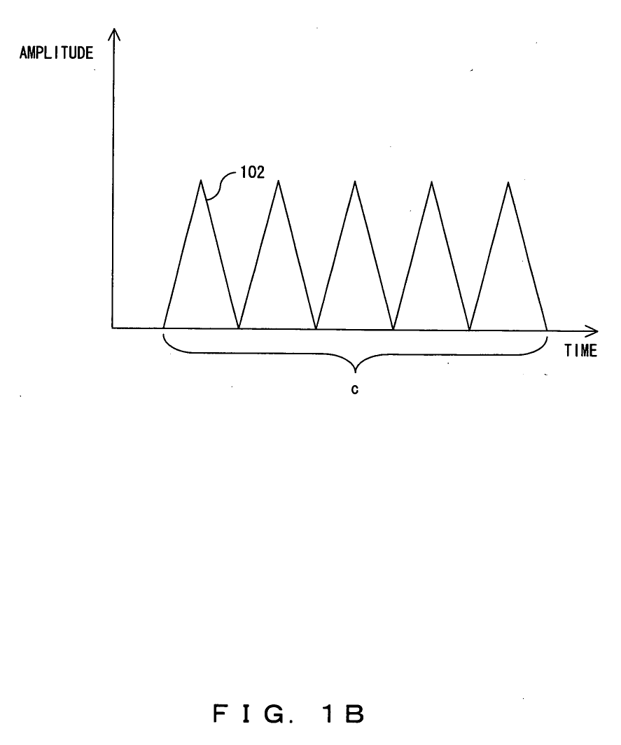

FIG. 1A shows the voice waveform of the laughter of a mild asthmatic, and FIG. 1B shows the voice waveform of the laughter of a healthy person. The waveforms shown in FIGS. 1A and 1B are conceptual waveforms indicating the approximate tendency.

FIG. 1A shows a voice waveform 101 of a mild asthmatic. This graph shows the amplitude of an audio signal against time for a frequency. The voice waveform 101 is sampled immediately after the start of laughter, and is composed of a portion a having large amplitude (intensity) immediately after the start of the laughter and a subsequent portion b having constant amplitude (intensity).

FIG. 1B shows a voice waveform 102 of a healthy person. This graph shows the amplitude of an audio signal against time for a frequency. The voice waveform 102 is sampled immediately after the start of laughter, and is composed of only a portion c having constant amplitude (intensity).

According to the first asthma diagnostic apparatus of the present invention, the waveform of a person to be diagnosed is compared with the waveform of a mild asthmatic sampled in advance as reference data, and the similarity is determined. According to the second asthma diagnostic apparatus, the feature value of the voice waveform of a mild asthmatic obtained by sampling and analyzing a plurality of voice waveforms of mild asthmatics is compared with the feature value obtained from the voice waveform of a person to be diagnosed to determine the similarity.

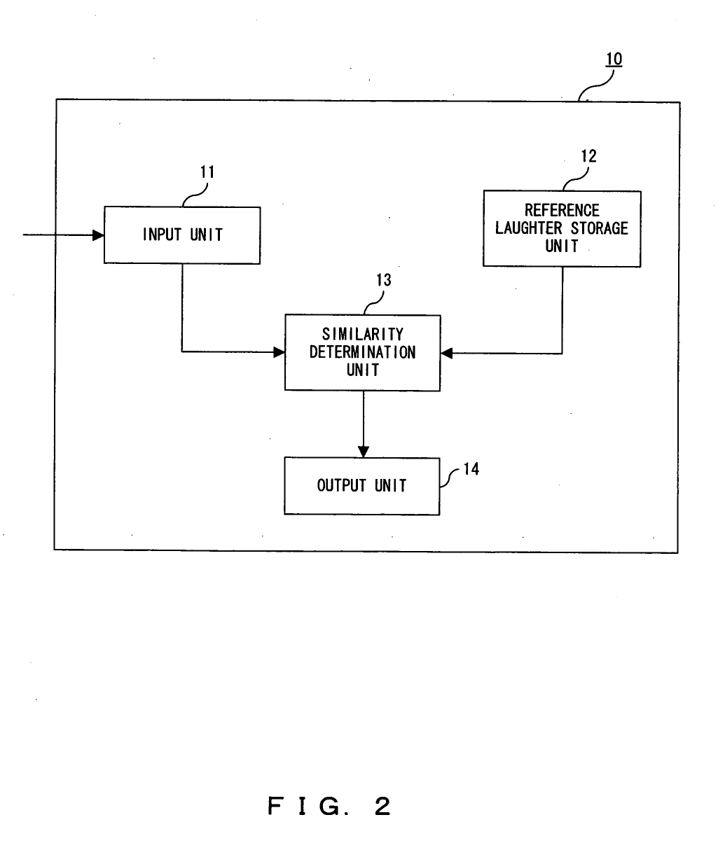

FIG. 2 is a block diagram showing the configuration of the asthma diagnostic apparatus according to the first embodiment of the present invention.

In FIG. 2, an asthma diagnostic apparatus 10 comprises a reference laughter storage unit 12 for storing the laughter of a mild asthmatic as reference data, an input unit 11 for inputting the laughter of a person to be diagnosed, a similarity determination unit 13 for determining the similarity between the laughter as the reference data and the input laughter, and an output unit 14 for outputting a determination result of the similarity. In the similarity determination unit 13, various algorithms in the field of audio recognition can be used as determining algorithms.

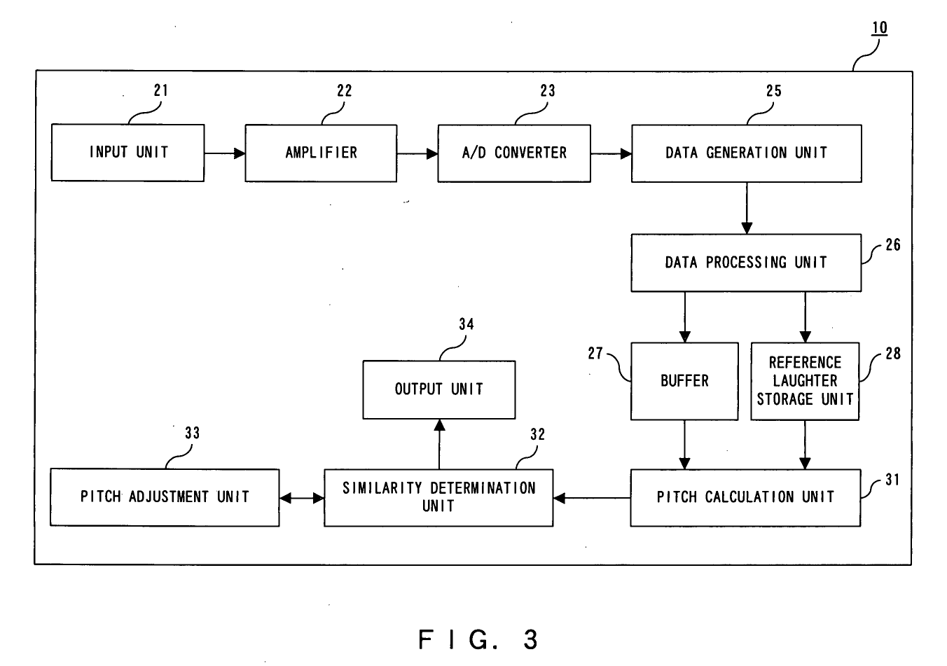

FIG. 3 is a block diagram showing a more detailed configuration of the asthma diagnostic apparatus 10 shown in FIG. 2 when DP matching is used as an audio recognition algorithm.

In FIG. 3, an amplifier 22 amplifies the audio signal input through an input unit 21, and an A/D converter 23 converts the amplified audio signal from an analog value to a digital value.

In FIG. 3, a data generation unit 25 inputs laughter data (laughter data for a predetermined period from the start of the laughter) of a person to be diagnosed converted to a digital value, and generates three-dimensional data indicating a frequency, intensity (amplitude), and time for the input laughter data. A data processing unit 26 stores the generated three-dimensional data in a buffer 27 as a laughter storage unit.

A pitch calculation unit 31 inputs the laughter of a person to be diagnosed stored in the buffer 27 or reference laughter stored in a reference laughter storage unit 28, and calculates the basic frequency (pitch) of the input laughter. A pitch corresponds to, for example, a fundamental frequency which depends on the air pressure from the lungs and is the reciprocal of the open/close period (vibration period) of the vocal cords. A pitch adjustment unit 33 obtains the correspondence between the pitches of two pieces of laughter data by using the pitch of each piece of laughter data calculated by the pitch calculation unit 31 when a similarity determination unit 32 determines the similarity between two types of laughter.

It is assumed that the reference laughter sampled from a mild asthmatic has already been processed by the data generation unit 25 and the data processing unit 26, and the resultant three-dimensional data has been stored in the reference laughter storage unit 28 which is a secondary storage unit.

The similarity determination unit 32 calculates a sum of the intensity of laughter data for each point in time included in a predetermined frequency range. A “predetermined frequency range” refers to a frequency range predetermined by two types of laughter to be compared. That is, the pitch adjustment unit 33 determines that “the first frequency range for the reference laughter data corresponds to the second frequency range for the laughter data of a person to be diagnosed”.

The similarity determination unit 32 determines the similarity between the reference laughter data and the laughter data of a person to be diagnosed by comparing the relationship between the obtained sum of intensity (amplitude) and the time of the reference laughter data and the laughter data of a person to be diagnosed. That is, when the characteristic intensity change detected in the starting portion of the laughter of a mild asthmatic as shown in FIG. 1 is also detected in the laughter of the person to be diagnosed, it is determined that the laughter of the person to be diagnosed is similar to the laughter of a mild asthmatic. An output unit 34 determines whether or not the person to be diagnosed is a mild asthmatic based on the determination result of the similarity determination unit 32.

The function of determining the data type of laughter data can be assigned to the data processing unit 26. That is, the data type of laughter data is initialized as “uncertain” at the input time, and for the laughter data having the data type “uncertain”, the data processing unit 26 allows the three-dimensional data generated for the laughter data to be stored in the buffer 27. On the other hand, when the laughter data of data type “uncertain” is determined to be similar to the reference laughter in the similarity determination described later, that is, if it is determined that the laughter of a person to be diagnosed is similar to the laughter of a mild asthmatic, the data processing unit 26 can change the data type to “reference data”, a confirmation message as to whether or not the laughter is to be stored in the secondary storage (reference laughter storage unit) can be displayed in the message display area of the asthma diagnostic apparatus, and the laughter data of the person to be diagnosed can be stored in the reference laughter storage unit when an answer to store the data is returned. If it is determined that that the laughter of the person to be diagnosed is not similar by the similarity determination, a confirmation message as to whether or not the laughter data of the person to be diagnosed is to be discarded is displayed in the message display area of the asthma diagnostic apparatus. If an answer to discard the data is returned, the laughter data of the person to be diagnosed can be discarded. In any case, the confirmation message can be suppressed and the storage or discarding can be automatically performed.

With regards to the sampled reference laughter of a mild asthmatic, the pitch can be calculated in advance by the pitch calculation unit 31 to store the calculated pitch together with the three-dimensional data obtained as a processing result of the data generation unit 25, in advance, in the reference laughter storage unit 28 as a secondary storage unit.

It is also possible to obtain the relationship between the above-mentioned intensity (amplitude) sum and the time based on the reference laughter data and the laughter data of a person to be diagnosed, and instead of determining the similarity between the relationships of intensity (amplitude) sum against time, the similarity between each pair of frequencies associated by the pitch adjustment unit 31 can obtained, and when there are more than a predetermined number of pairs whose result of similarity determination exceeds a predetermined value, it can be determined that the reference laughter data is similar to the laughter data of a person to be diagnosed.

It is preferable that the reference laughter storage unit 12 stores the laughter of a plurality of mild asthmatics as references. In this case, the similarity determination unit 13 determines the similarity between the laughter of the plurality of mild asthmatics and the laughter of a person to be diagnosed, for example, determines that the laughter of the person to be diagnosed is similar to at least one of the laughter of the plurality of mild asthmatics. In this case, if it is determined that the laughter of the person to be diagnosed is similar to at least one of the plurality of mild asthmatics, the person to be diagnosed is determined to be a mild asthmatic.

The asthma diagnostic apparatus 10 can be configured as dedicated hardware. In this case, for example, the output unit 14 can make audio output of a determination result using a buzzer, or output a determination result by turning on an illumination unit.

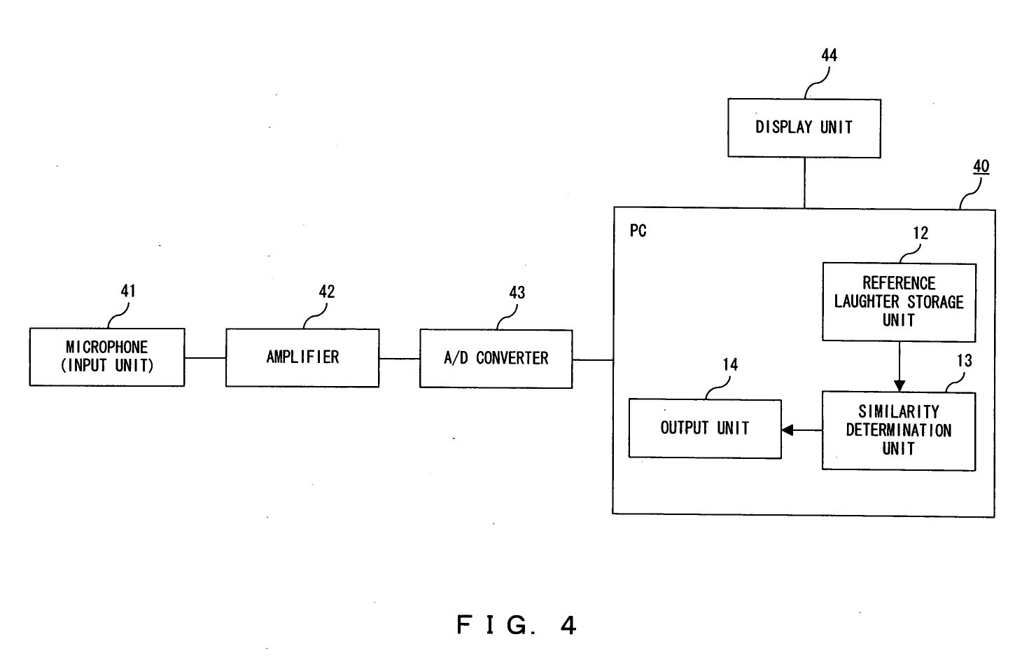

The asthma diagnostic apparatus 10 can also be constituted by installing some of the functions (similarity determination unit 13, output unit 14) in a personal computer 40 as shown in FIG. 4, and by externally connecting the remaining functions (microphone (input unit) 41, amplifier 42, A/D converter 43), or by using the function (reference laughter storage unit 12) of the personal computer 40. In this case, for example, the output unit 14 outputs and displays a determination result in the message display area of a display unit 44 of the personal computer 40.

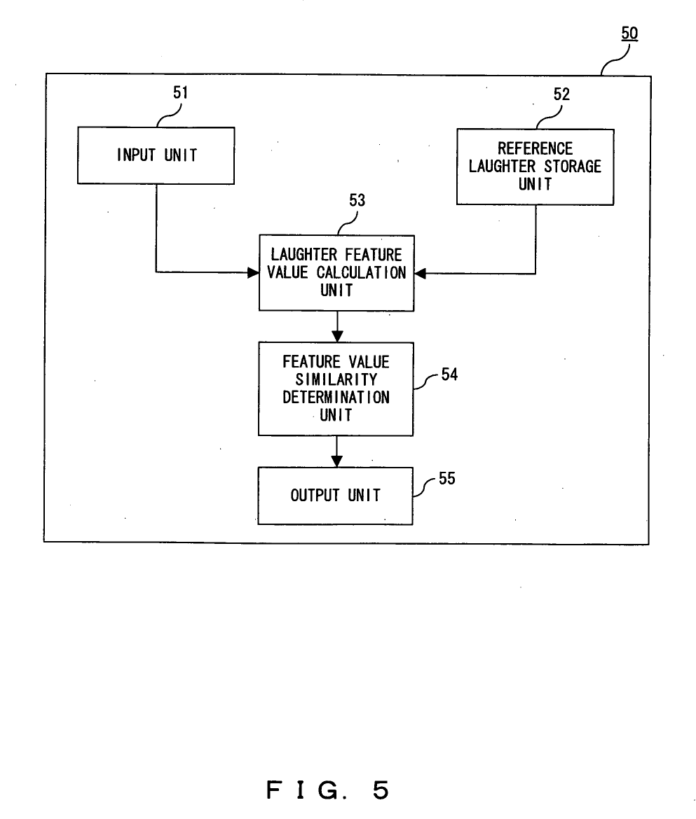

FIG. 5 is a block diagram showing the configuration of the asthma diagnostic apparatus according to the second embodiment of the present invention.

In FIG. 5, an asthma diagnostic apparatus 50 comprises a reference laughter storage unit 52 for storing the laughter of a mild asthmatic as reference data, an input unit 51 for inputting the laughter of a person to be diagnosed, a laughter feature value calculation unit 53 for calculating a feature value of input laughter or laughter as reference data, a feature value similarity determination unit 54 for determining the similarity between the calculated feature value of the laughter as reference data and a feature value of the input laughter, and an output unit 55 for outputting a determination result of the similarity between the feature values.

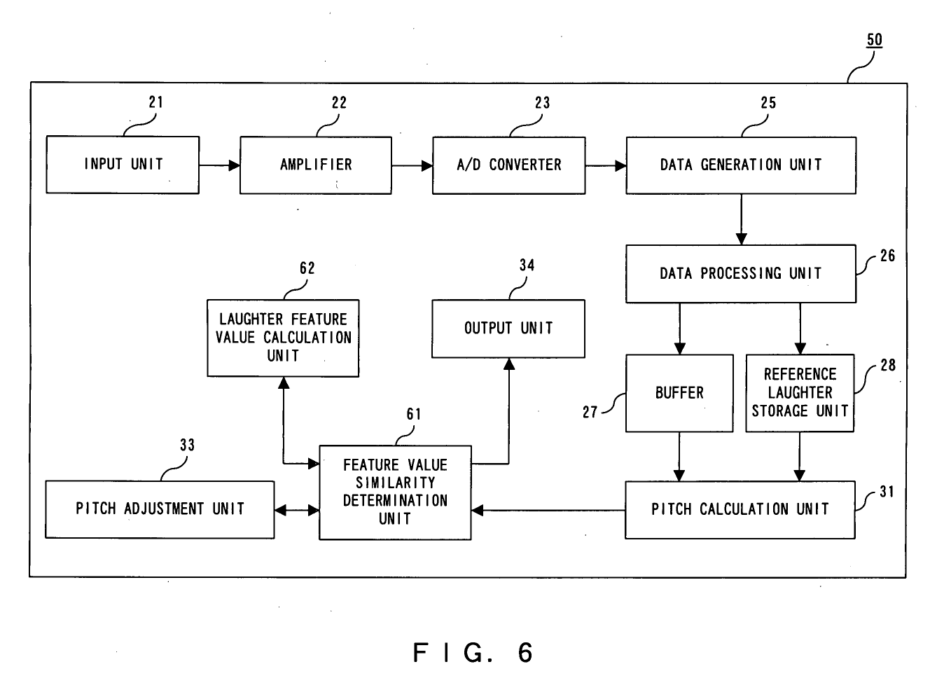

FIG. 6 is a block diagram of the detailed configuration of an asthma diagnostic apparatus 50 shown in FIG. 5 when DP matching is used as an audio recognition algorithm.

In FIG. 6, since the process up to obtaining the relationship between the intensity (amplitude) sum and the time is the same as the process shown in FIG. 3, it is omitted here. In the present embodiment, a feature value stored in the reference laughter storage unit 28 is, for example, the ratio (range of the ratio) of the large amplitude immediately after the utterance of laughter to the amplitude of the subsequent flat portion.

A laughter feature value calculation unit 62 calculates for laughter data the ratio of the amplitude immediately after laughter is uttered and the amplitude after a predetermined period has passed from the point immediately after the laughter. A feature value similarity determination unit 61 compares a feature value calculated based on the reference laughter data with a feature value calculated based on the input laughter data, and when the feature value (ratio) obtained from the input laughter data is contained within a predetermined interval including the feature value obtained from the reference laughter data, it is determined that the reference laughter data is similar to the input laughter data. In this case, the person to be diagnosed is determined to be a mild asthmatic.

The asthma diagnostic apparatus according to the present embodiment can include an amplitude adjustment unit (regulator) not shown in the attached drawings in place of the laughter feature value calculation unit 62. In this case, the amplitude adjustment unit adjusts the scale of, for example, the y-axis so that one of the maximum values on the graph of the intensity (amplitude) sum against time obtained for two pieces of laughter data to be compared can comply with the other. When either one of the y-axis of the comparison targets is scaled, the feature value similarity determination unit 61 compares the amplitude if a predetermined time has passed immediately after laughter is uttered between the reference laughter data and the input laughter data. When the amplitude of the input laughter data at the time lies within a predetermined interval containing the amplitude of the reference laughter data at the time, it is determined that the reference laughter data is similar to the laughter data.

As necessary, an attribute (gender, age, etc.) of the person who is the source of the reference laughter data can be added to the laughter data stored in the reference laughter storage unit 28. In this case, when the laughter of a person to be diagnosed is input, the attribute of the person to be diagnosed can be input via the person to be diagnosed attribute input unit which is not shown in the attached drawings. Thus, more appropriate asthma diagnosis can be performed depending on the gender, age, etc. of the person to be diagnosed.

For the reference laughter sampled from a mild asthmatic, the calculation of pitch by the pitch calculation unit 31 and the calculation of a feature value by the laughter feature value calculation unit 62 can also be performed in advance, and the calculated pitch and feature value can be stored in advance in the reference laughter storage unit 28 as a secondary storage unit together with the three-dimensional data of the processing result by the data generation unit 25.

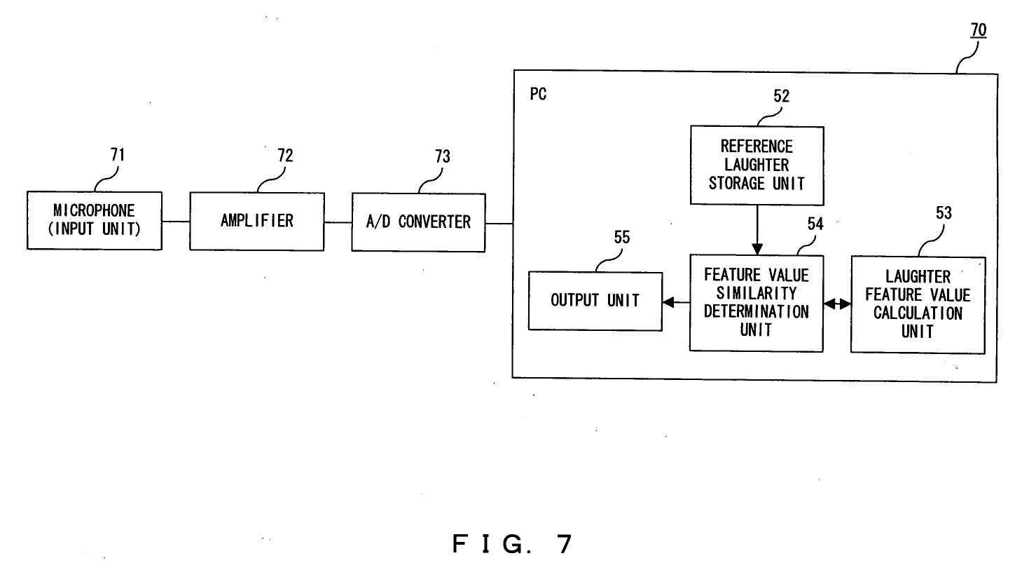

The asthma diagnostic apparatus 50 shown in FIG. 5 can be comprised as dedicated hardware. Or, as shown in FIG. 7, the asthma diagnostic apparatus 50 can be comprised by installing some of the functions (laughter feature value calculation unit 53, feature value similarity determination unit 54, and output unit 55) in a personal computer 70, and the remaining functions (microphone (input unit) 71, amplifier 72, and A/D converter 73) externally connected to the personal computer or using the function (reference laughter storage unit 52) of the personal computer.

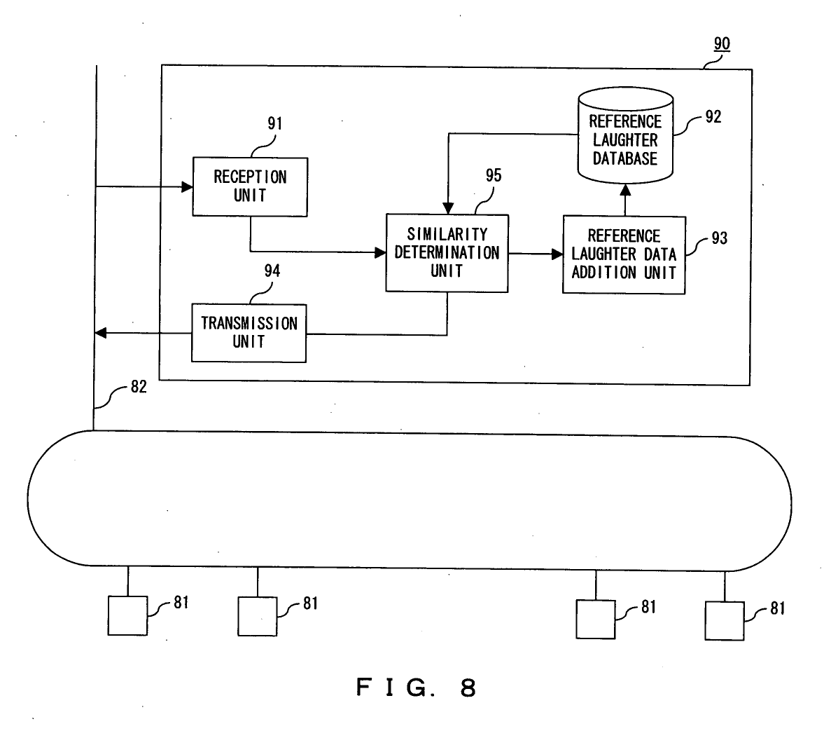

FIG. 8 shows the configuration of the asthma diagnostic system according to the third embodiment of the present invention.

In FIG. 8, the asthma diagnostic system is configured by having an asthma diagnostic server apparatus 90 connected to one or more terminals 81 over a network 82.

In the third embodiment, as shown in FIG. 8, a user who diagnoses a person to be diagnosed as to whether or not they are a mild asthmatic transmits the laughter of the person to be diagnosed to the asthma diagnostic server apparatus 90 from the terminal 81 over the network 82.

The asthma diagnostic server apparatus 90 which receives the laughter of the person to be diagnosed via a reception unit 91 uses a similarity determination unit 95 to compare the laughter of the person to be diagnosed with the laughter of a mild asthmatic as one or more pieces of reference data stored in a reference laughter database 92, and determines the similarity between them. A determination result of the similarity of the laughter of the person to be diagnosed is returned to the terminal 81 which is transmitted via a transmission unit 94. In determining the similarity, when it is determined that the received laughter of the person to be diagnosed is the laughter of a mild asthmatic, a reference laughter data addition unit 93 adds the received laughter of the person to be diagnosed to the reference laughter database 92.

In the configuration of the third embodiment, the laughter of a mild asthmatic as reference data can be efficiently collected.

The function of performing the asthma diagnostic process according to the present invention can also be realized as software. In this case, the software is stored in a storage medium, and loaded into the memory in an information processing device for execution.

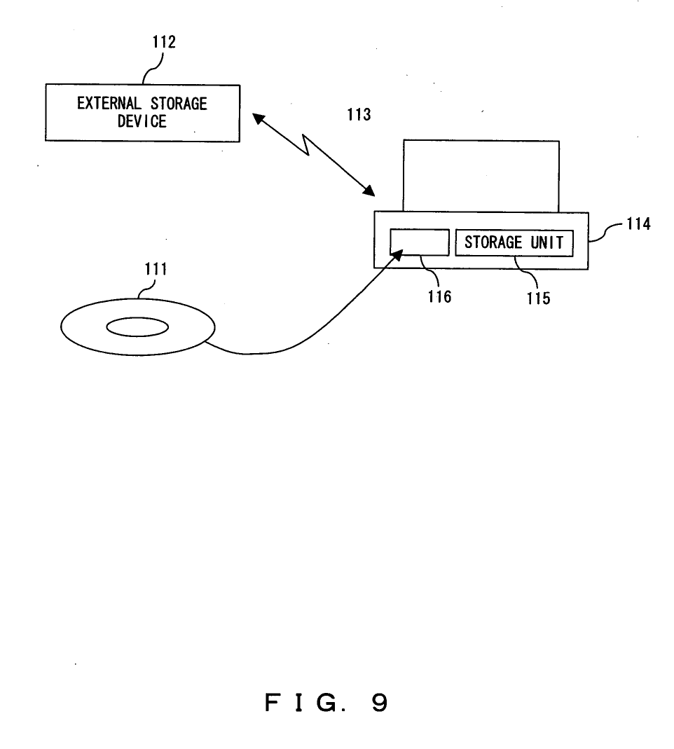

As shown in FIG. 9, the above-mentioned storage medium includes a portable storage medium 111 such as a CD-ROM, a flexible disk (MO, DVD, removable hard disk), etc. removable from a medium drive device 116, an external storage device 112 to which a program can be transmitted over a network 113, and a storage unit (hard disk, etc.) 115 inside the body 114 of the information processing device. A program for performing various processes according to the present embodiment is loaded into memory in the body 114 from the above-mentioned storage medium for execution.

In the present invention, the method of collecting the laughter of a mild asthmatic is the important point. For example, the laughter of a mild asthmatic can be efficiently collected using the system configuration according to the third embodiment, or from a patient who has almost recovered from asthma, using the asthma diagnostic apparatus of the system according to the present invention, and who gives permission to obtain their own data.

What is claimed is:

1. An asthma diagnostic apparatus which diagnoses a person to be diagnosed and determines whether or not the person is a mild asthmatic, comprising:
a reference laughter storage unit storing laughter of a mild asthmatic as reference data;
an input unit inputting laughter of a person to be diagnosed;
a similarity determination unit determining similarity between the laughter as the reference data and the input laughter; and
an output unit outputting a determination result of the similarity.

2. The apparatus according to claim 1, wherein
the reference laughter storage unit stores laughter of a plurality of asthmatics, and the similarity determination unit determines the person to be diagnosed to be a mild asthmatic when the laughter of the person to be diagnosed is determined to be similar to the laughter of at least one of the laughter of the plurality of asthmatics.

3. The apparatus according to claim 1, further comprising
a laughter storage unit storing input laughter.

4. The apparatus according to claim 1, wherein
the output unit outputs an audio determination result by a buzzer.

5. The apparatus according to claim 1, wherein
the output unit outputs a determination result by turning on an illumination unit.

6. The apparatus according to claim 1, wherein
the output unit outputs and displays a determination result in a message display area of a display device of the apparatus.

7. An asthma diagnostic apparatus which diagnoses a person to be diagnosed and determines whether or not the person is a mild asthmatic, comprising:
a reference laughter storage unit storing laughter of a mild asthmatic as reference data;
an input unit inputting laughter of a person to be diagnosed;
a laughter feature value calculation unit calculating a feature value of input laughter or laughter as reference data;
a feature value similarity determination unit determining similarity between the calculated feature value of laughter as reference data and a feature value of the input laughter; and
an output unit outputting a determination result of similarity of the feature value.

8. An asthma diagnostic method of a computer which diagnoses a person to be diagnosed and determines whether or not the person is a mild asthmatic, comprising:
determining similarity between laughter of a mild asthmatic as reference data stored in a storage device of the computer and laughter of a person to be diagnosed input through an input device of the computer; and
outputting a determination result of the similarity.

9. The method according to claim 8, wherein
a determination result of the similarity is output and displayed in a message display area of the display device of the apparatus.

10. An asthma diagnostic method of a computer which diagnoses a person to be diagnosed and determines whether or not the person is a mild asthmatic, comprising:
calculating a feature value of laughter of a mild asthmatic as reference data stored in a storage device of a computer;
calculating a feature value of input laughter;
determining similarity between the feature value of the laughter as the calculated reference data and the input laughter; and
outputting a determination result of the similarity of the feature value.

11. A storage medium storing a program used to direct a computer to determine whether or not a person to be diagnosed is a mild asthmatic, the program comprising:
a step of determining similarity between laughter of a mild asthmatic as reference data stored in a storage device of the computer and laughter of a person to be diagnosed input through an input device of the computer; and
a step of outputting a determination result of the similarity.

12. The storage medium according to claim 11, wherein
in the determination result step of the similarity determination, a determination result of the similarity is output and displayed in a message display area of the display device of the apparatus.

13. A storage medium storing a program used to direct a computer to determine whether or not a person to be diagnosed is a mild asthmatic, the program comprising:
a step of calculating a feature value of laughter of a mild asthmatic as reference data stored in a storage device of a computer;
a step of calculating a feature value of input laughter;
a step of determining similarity between the feature value of the laughter as the calculated reference data and the input laughter; and
a step of outputting a determination result of the similarity of the feature value.

14. An asthma diagnostic system which diagnoses a person to be diagnosed and determines whether or not the person is a mild asthmatic, comprising:
an asthma diagnostic server apparatus comprising:
a reference laughter database storing laughter of a mild asthmatic as reference data;
a similarity determination unit determining similarity between received laughter of a person to be diagnosed and laughter of the reference data; and
a transmission unit returning a determination result of the similarity to a terminal of a transmitter of laughter of a person to be diagnosed; and
one or more terminals transmitting laughter of a person to be diagnosed to the server apparatus.

15. A server apparatus for use in an asthma diagnostic system which diagnoses a person to be diagnosed and determines whether or not the person is a mild asthmatic, comprising
an asthma diagnostic server apparatus comprising:
a reference laughter database storing laughter of a mild asthmatic as reference data;
a similarity determination unit determining similarity between laughter of a person to be diagnosed received from a terminal transmitting laughter of a person to be diagnosed, and laughter of the reference data; and
a transmission unit returning a determination result of the similarity to the transmitting source terminal of laughter of a person to be diagnosed.

16. The apparatus according to claim 15, further comprising
a reference laughter data addition unit adding received laughter of a person to be diagnosed to the reference laughter data when the received laughter of the person to be diagnosed is determined to be laughter of a mild asthmatic in determining the similarity.
